(19) United States
(12) Patent Application Publication
(10) Pub. No.: US 2021/0401080 A1
(43) Pub. Date: Dec. 30, 2021

(54) TRANSPARENT FACIAL MASKS AND OTHER PROTECTIVE GEAR

(71) Applicant: Ayyappan K. RAJASEKARAN, Glen Mills, PA (US)

(72) Inventor: Ayyappan K. RAJASEKARAN, Glen Mills, PA (US)

(21) Appl. No.: 17/360,105

(22) Filed: Jun. 28, 2021

Related U.S. Application Data
(60) Provisional application No. 63/045,413, filed on Jun. 29, 2020.

(51) Int. Cl. A41D 13/11; A41D 31/08; A62B 23/02

(52) U.S. Cl. CPC A41D 13/1115; A41D 13/1161; A41D 13/1209; A62B 23/025; A41D 31/08

(57) ABSTRACT

Transparent facial masks of regenerated cellulose and other personal protective gear such as gowns, booties, surgical caps, surgical drapes, gloves and eyewear are provided.

This patent application claims the benefit of priority from U.S. Provisional Application Ser. No. 63/045,413, filed Jun. 29, 2020, teachings of which are herein incorporated by reference in their entirety.

### TECHNICAL FIELD

This disclosure relates to facial masks and other protective gear prepared from transparent regenerated cellulose.

### BACKGROUND

Face masks protect the wearers' nose and mouth from contact with droplets, splashes and sprays that may contain germs. They also prevent the spread of any infectious germs from the wearer to others. The CDC recommends widespread use of simple cloth face coverings to help prevent transmission of the virus by people who have Covid-19 but do not know it. In the Covid-19 era, masks are mandatory in most of the states in the U.S. and many countries worldwide. Thus, there is a large need for simple masks to protect people from viral infection and spreading of the disease.

It has been shown that wearing a mask significantly reduces the transmission of Covid-19 (Feng et al. Lancet Respir Med. 2020; 8 (5):434-6; World Health Organization. Advice on the use of masks in the context of COVID-19: interim guidance [Internet]. Geneva: World Health Organization; 2020 Apr. 6; Greenhalgh et al. BMJ. 2020; 369:m1435; Centers for Disease Control and Prevention. Recommendation regarding the use of cloth face coverings, especially in areas of significant community-based transmission [Internet]. Atlanta (Ga.): CDC; [page last reviewed 2020 Apr. 3). Most recently, several reports have stressed the importance of face masks in the protection against corona virus. Lyu and Wehby reported that community use of face masks significantly reduces the spread of Covid-19 (Lyu & Wehby, Community Use of Face Masks And COVID-19: Evidence From A Natural Experiment Of State Mandates In The US: Health Affairs June 2020).

There are three types of masks: surgical, N95 and cloth masks. Surgical masks, also called medical or procedure masks, are a loose-fitting disposable mask. They protect the wearer and others by reducing exposure to the saliva and respiratory secretions originating from each other. At this time, the U.S. Food and Drug Administration has not approved any type of surgical mask specifically for protection against the coronavirus, but these masks may provide some protection when N95 masks are not available.

The N95 mask is a type of respirator. It uses an electrostatic filter that can filter out both large and small particles when the wearer inhales. As the name indicates, the mask is designed to block 95% of very small particles.

Some N95 masks have valves that make them easier to breathe through. With this type of mask, unfiltered air is released when the wearer exhales. However, because the valve releases unfiltered air when the wearer breathes out, this type of mask does not prevent the wearer from spreading the virus. For this reason, some places have banned N95 masks with these valves.

While surgical and N95 masks are in short supply and must be reserved for health care providers, cloth masks are easy to find and can be washed and reused. Cloth masks are cheap and simple to make. Instructions are easy to find online. Masks can be made from common materials, such as sheets made of tightly woven cotton. The CDC website even includes directions for no-sew masks made from bandannas and T-shirts. Cloth masks should include multiple layers of fabric.

There is little evidence evaluating the use of cloth masks with respect to Covid-19 (estimated size 0.13 microns) specifically. Homemade cloth masks (without filters) may prevent the transmission of some particulate matter but are much less effective than manufactured surgical masks at preventing transmission of influenza (MacIntyre et al. BMJ Open 2015; 5: e006577. doi:10.1136/bmjopen-2014-006577). There is some evidence that certain materials are more helpful than others. Mouth and nose covering with a shawl has been suggested to protect viral transmission. While these types of masks may not protect the wearer to any significant extent, they may decrease the spread of the virus from asymptomatic persons and limit touching of the face.

Wearing a mask continues to be an important tool to prevent virus spread even with the advent of vaccines or effective drugs. Billions of surgical and N95 masks have been made to date and their production will continue for a long time until the Covid-19 situation is eliminated. Since these masks are made of plastic material, disposal is a major environmental issue now and for the future. See Corona virus disposable masks causing enormous plastic waste (Justin Parkinson, BBC, https with the extension bbc.com/news/uk-politics-54057799 of the world wide web), Accumulation of plastic waste during Covid-19, (Tanveer Adyel, Science, 11 Sep. 2020, Vol. 369, Issue 6509, pp. 1314-1315 https with the extension science.sciencemag.org/content/369/6509/1314 of the world wide web).

Although effective, there are multiple problems associated with currently available masks. For example, currently available surgical and N95 are made of plastic materials and disposal is not environmentally friendly. In addition, these masks are non-transparent making facial recognition hard and emotions less visible. These masks are also not supportive for communication with deaf people. Further, with respect to N95 masks, manufacturing is complex and costly.

### SUMMARY OF THE INVENTION

An aspect of the present disclosure relates to personal protective equipment (PPE), at least a portion of which comprises a transparent cellulose film.

In one nonlimiting embodiment, the cellulose film is coated.

In one nonlimiting embodiment the coating is a heat seal coating.

In one nonlimiting embodiment, the cellulose film is treated with a flame-retardant.

In one nonlimiting embodiment, the cellulose film comprises a heat seal coating and is treated with a flame-retardant.

In one nonlimiting embodiment, the PPE is a mask comprising a body portion sized to cover the nose and mouth of a user wherein at least a portion of the body portion comprises a transparent cellulose film. The mask further comprises a fastening means to attach the mask to the user. Nonlimiting examples of transparent cellulose film which can be used in the mask include regenerated cellulose sausage casing, cellophane and dialysis membrane.

Other PPE equipment which can be prepared from the transparent cellulose film and are included within the scope of this disclosure include, but are not limited to, gowns, booties, surgical caps, surgical drapes, eyewear and gloves.

### BRIEF DESCRIPTION OF THE FIGURES

FIG. 1 is a diagram of a nonlimiting embodiment of a mask of the present invention wherein a transparent cellulose film has been inserted into part of the body portion of a cloth facial mask.

FIG. 2 is a diagram of another nonlimiting embodiment of a mask of the present invention wherein the entire body portion comprises a transparent cellulose film. In this nonlimiting embodiment, the film has 3 pleats for better fit.

FIG. 3 contains drawings of 2 mask embodiments of FIG. 1 with the transparent cellulose film inserted at the nose and mouth part of the body portion of the mask.

FIG. 4 is a drawing of a mask of FIG. 2.

FIG. 5 is a drawing of a glove prepared from the cellulose film.

FIG. 6 and FIG. 7 are drawings of gowns prepared from the cellulose film.

### DETAILED DESCRIPTION

In the Covid-19 pandemic era, facial masks or face coverings have become an essential component of daily life. Masks protect people from coming in contact with aerosol containing the viruses originated during talking, sneezing or coughing. Since there is a large demand for masks many kinds of materials have been tested and used as masks by the public.

In the present invention, regenerated cellulose materials such as transparent sausage casings, cellophane and dialysis membrane are used in masks to protect people from splashes of aerosol originated during talking, sneezing or coughing.

Cellulose itself was purified from the wood in 1885 and as early as 1910 regenerated cellulose was available in sheet form in France under the name cellophane. Cellophane was widely used for food packing as sausage skin from about 1920 onwards. Further, during the 1930s sausage skin was used in the laboratory for dialysis experiments due to its excellent diffusion properties. In the late 1930s, sausage skin was used in the discovery of artificial kidney and process of dialysis. See Cameron S J, Practical hemodialysis began with cellophane and Heparin: the crucial role of William Thalhimer 1884-1961, Nephrol Dial Transplantation, 2000 15: 1086-1091.

Today, cellophane generated from regenerated cellulose is extensively used as dialysis membrane in medical research and devices. Because of its selective permeability, it was used in renal dialysis as an artificial kidney to eliminate small molecules from the blood.

Since these membranes are permeable only to small molecules, large molecular weight viruses cannot pass through. In fact, often dialysis is used in the final step of virus purification to concentrate the virus by getting rid of all contaminating small molecules. In other words, virus cannot pass through the dialysis membrane.

A process for producing regenerated cellulose is set forth in U.S. Pat. No. 4,546,023, teachings of which are incorporated herein by reference in their entirety.

Processes for controlling wall thickness and tubular diameter are set forth in U.S. Pat. No. 5,451,364, teachings of which are incorporated herein by reference in their entirety.

Finished tubes or casings produced in accordance with these processes are composed of pure cellulose, food grade glycerin, and water. Cellulose casings are permeable to smoke and moisture to some extent but are impermeable to organic molecules.

Cellophane is one of the most used regenerated cellulose products, particularly in the food packing industry due to its low permeability to air, oils, greases, bacteria and water. To manufacture a cellophane sheet, an alkaline solution of cellulose fibers (usually wood or cotton) known as viscose is extruded through a narrow slit into an acid bath. The acid regenerates the cellulose, forming a film. Further treatment, such as washing and bleaching, yields cellophane. The sheet generated can be coated with different agents to achieve varied functions. For example, a heat seal layer composed of either polyhydroxybutyrate-valerate (“PHBV”) rich resin or polyhydroxy-alkanoate (“PHA”) resin, with certain properties that allow it to be coextruded as a heat seal layer for a biaxially oriented multi-layer polymer film is described in U.S. Pat. No. 9,162,421, teachings of which are incorporated herein by reference in their entirety. Coating with nitrocellulose has been disclosed to reduce water permeability of cellophane. See U.S. Pat. No. 4,072,785, teachings of which are incorporated herein by reference in their entirety. Nonlimiting examples of such coated cellophane includes NatureFlex-NVR, NatureFlex-NVS and NatureFlex-NK available from Futamura.

The manufacturing of dialysis membrane from regenerated cellulose is described in U.S. Pat. No. 4,741,927, teachings of which are incorporated herein by reference in their entirety. Since dialysis membranes can be generated with various molecular weight cut off values, they can be made specifically to block viral transmission.

Sausage casings, cellophane and dialysis membranes are all easy and cost effective to manufacture. Further, as these cellulose materials are transparent as well a biodegradable, the inventor herein has found them to be useful materials to incorporate into facial masks used to protect people during this Covid-19 pandemic.

Regenerated cellulose is flammable. However, cellulose-based fibers owing to the presence of hydroxyl group can be suitably flame retarded with phosphorus based flame-retardants (Gaan, S.; Sun, G. J. Anal. Appl. Pyrolysis 2007, 78, 371-377; Gaan, S.; Sun, G. J. Anal. Appl. Pyrolysis 2009, 84, 108-115; Gaan et al. Polym. Degrad. Stab. 2008, 93, 99-108; Gaan et al. WO2009153034A1, 23 Dec. 2009; Rupper et al. J. Anal. Appl. Pyrolysis 2010, 87, 93-98; Salimova et al. PMSE Prepr. 2008, 98, 250-251.) It was recently demonstrated that the efficiency of ethyl ester phosphoramidates could be greatly improved by incorporating a hydroxyl-terminating alkyl group linked to the nitrogen atom (See Gaan et al. Polym. Degrad. Stab. 2009, 94, 1125-1134. There are many flame-retardants available commercially such as Banfire from RDR technologies (NFPA, approved).

Cellulose sausage casings and dialysis membrane, when treated with a flame-retardant such as, but not limited to Banfire or another nontoxic flame-retardant, are expected to_meet the requirements of bacterial filtration efficiency (BFE), differential pressure (μP) particulate filtration efficiency (PFE), fluid resistance, and textile flammability to meet American Society for Testing and Materials (ASTM International) level 1 barrier protection standard and be useful in facial masks.

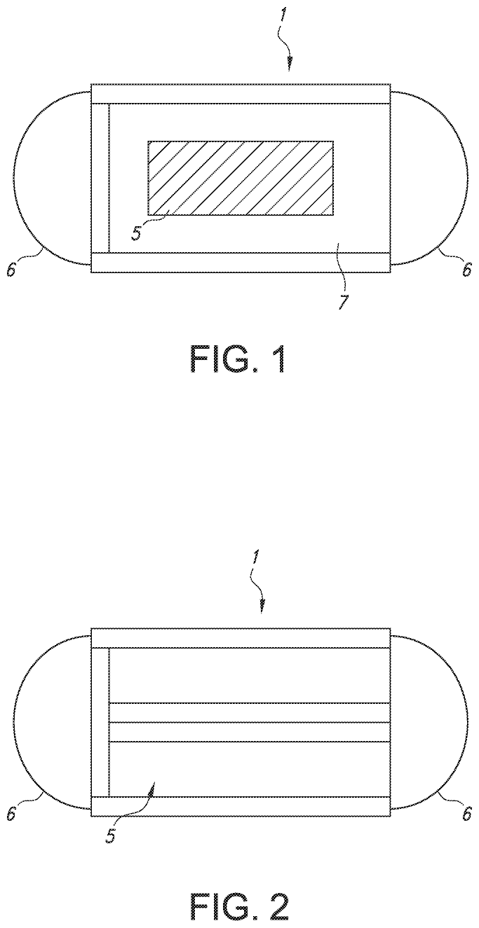

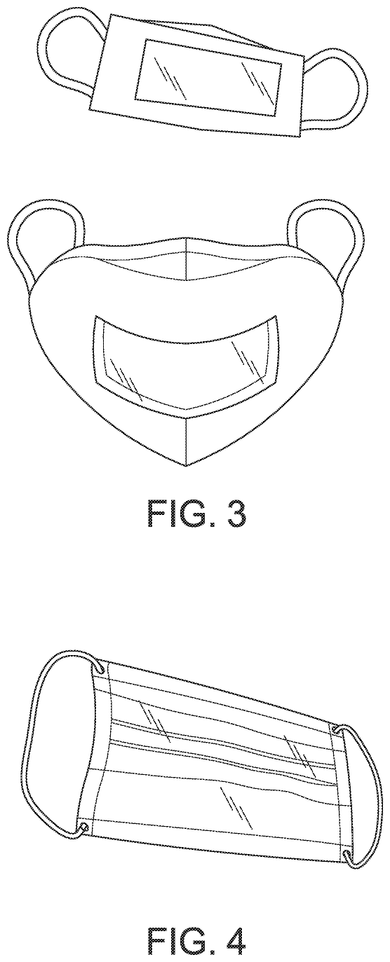

In one embodiment of the present invention, as depicted in FIGS. 1 and 3, a cloth mask is modified to comprise a cellulose film insert 5 in the body portion adjacent to at least the mouth portion of the mask. As shown in FIGS. 1 and 3, in this nonlimiting embodiment, the cellulose film 5 is lined by a cloth margin 7 to make up the body portion of the mask 1.

By “body portion”, as used herein, it is meant the section of the face mask that covers the nose and mouth of a wearer. The body portion will be typically sized to be about 175-200 mm horizontally and about 90-100 mm vertically.

In the nonlimiting mask embodiment depicted in FIGS. 1 and 3, the center hole in the mouth and the nose region comprising the cellulose film insert will be about 100-110 mm horizontally and about 45-50 mm vertically.

In another nonlimiting embodiment of the present invention, as depicted in FIGS. 2 and 4, the entire body portion of the mask 1 comprises the cellulose film 5. In this embodiment, the film may be pleated with one or more folds to provide for better comfort to the wearer. The depth of the pleat will be about 14 mm.

In another nonlimiting embodiment, the cellulose film is inserted in a mask between two cloth layers to enhance protection of the mask against viral particles.

Use of this biodegradable material for face masks is environment friendly and prevents accumulation of plastics used in the manufacturing of currently available masks.

Masks of the present invention further comprise a fastening means 6 to attach the mask 1 to the wearer. Nonlimiting examples include ear loops produced from an elastic material or strings, preferable comprises of a biodegradable material such as cotton, which tie around the ears or at the back of the head of a wearer.

In some nonlimiting embodiments, the mask may further comprise a malleable member at the top binding of the body portion which can be configured to closely fit the contours of the nose and upper cheeks of the wearer. The malleable member is preferably constructed from a metal strip with a rectangular cross-section, but may be a moldable or a malleable metal or alloy, plastic, or any combination thereof.

In some nonlimiting embodiments, the mask may be fitted with a breathing valve or an air filter containing activated charcoal.

Use of this less expensive and abundantly available biodegradable material in masks makes their production much less complex and more cost effective, thus providing a means to provide more masks worldwide. Further, use of this biodegradable material will have less impact on the environment. In addition, transparency of at least a portion of the mask allows for visibility of emotions of the wearer and communication of the wearer with deaf individuals.

As will be understood by the skilled artisan upon reading this disclosure, other PPE equipment can also be prepared from the cellulose film. Nonlimiting examples include gowns, eyewear, booties, surgical caps, surgical drapes and gloves.

In one nonlimiting embodiment, the cellulose film used in the PPE is coated.

In one nonlimiting embodiment the coating is a heat seal coating.

In one nonlimiting embodiment, the cellulose film used in the PPE is treated with a flame-retardant.

In one nonlimiting embodiment, the cellulose film used in the PPE is coated with a heat sealant and treated with a flame-retardant.

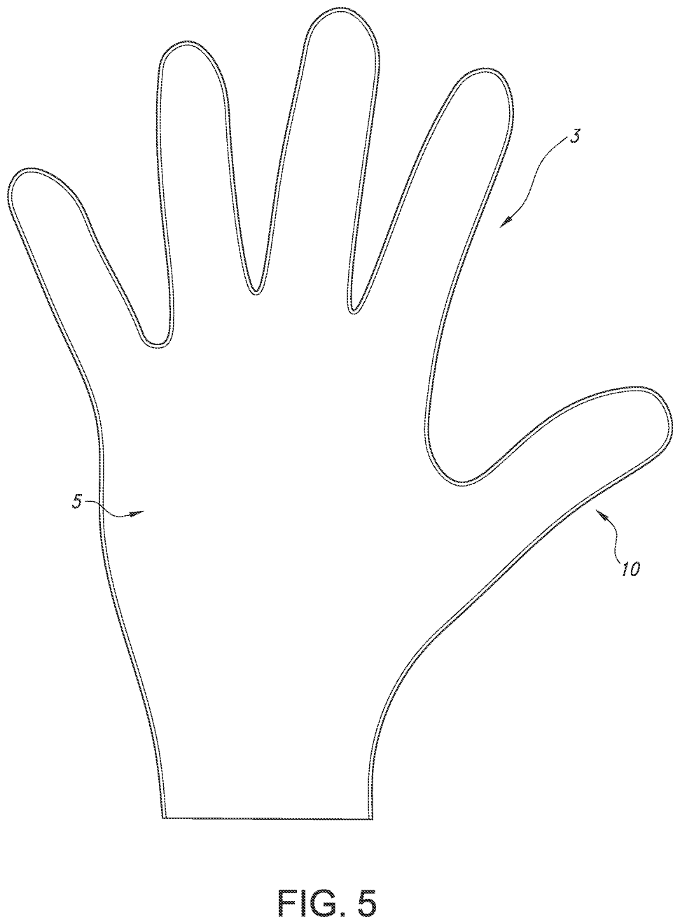

For example, disposable gloves comprising heat seal and flame-retardant coated cellophane can be manufactured similarly to disposable plastic gloves. In this nonlimiting embodiment, as depicted in FIG. 5, two layers of heat seal and flame-retardant coated cellophane 5 are heat sealed together at a seam 10 to form a glove 3 using glove-shaped molds similar to those used in the manufacturing of plastic hand gloves such as Polystar by adjusting the temperature to seal the cellophane. In some nonlimiting embodiments, elastic wrist cuffs are additionally included for better grip and protection. Different sizes of the gloves can be made by using different size of molds to manufacture small, medium, large and extra-large gloves.

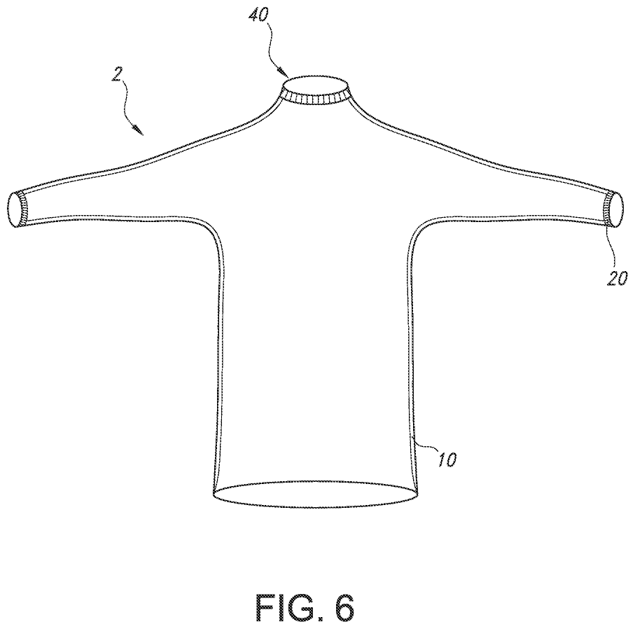

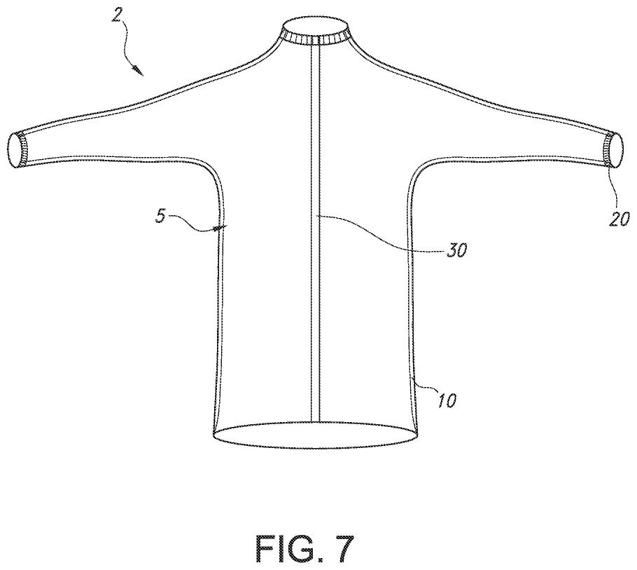

In another nonlimiting embodiment, disposable gowns 2 such as depicted in FIGS. 6 and 7 can be produced from the heat seal and flame retardant coated cellophane 5. In this embodiment, two layers of heat seal and flame-retardant coated cellophane 5 are heat sealed together at a seam 10 using molds similar to those used in the manufacturing of plastic gowns such as EM Apron Punch Mold and adjusting the temperature to seal the cellophane. In some nonlimiting embodiments, wrist cuffs 20 and/or neck holes 40 may be elasticized for better fit and protection of the gown 2. As shown in FIG. 6, the gown 2 can be made to fit overtop a wearer's head. Alternatively, as shown in FIG. 7, the gown 2 may have an opening 30 down the center front or back with a means for closure such as, but not limited to velcro or ties. Different sizes of the gowns can be made by using different size of molds to manufacture small, medium, large and extra-large gowns.

While the foregoing invention has been described in some detail for purposes of clarity and understanding, it will be appreciated by one skilled in the art from a reading of this disclosure that various changes in form and detail can be made without departing from the true scope of the invention and appended claims.

1. Personal protective equipment, at least a portion of which comprises a regenerated cellulose film.

2. The personal protective equipment of claim 1 wherein the regenerated cellulose film is coated with a heat-seal coating or treated with a flame retardant.

3. The personal protective equipment of claim 1 wherein the regenerated cellulose film is coated with a heat seal coating and treated with a flame retardant.

4. The personal protective equipment of claim 1 wherein the regenerated cellulose film comprises sausage casing, cellophane or dialysis membrane.

5. The personal protective equipment of claim 1 selected from the group consisting of masks, gowns, booties, surgical caps, surgical drapes, gloves and eyewear.

6. The personal protective gear of claim 5 which is a mask comprising a body portion at least a portion of which comprises the regenerated cellulose film and a fastening means to attach the mask to a wearer.

7. The mask of claim 6 wherein the regenerated cellulose film is inserted in the body portion of a cloth mask at an area adjacent to the mouth of the wearer to provide a transparent region in the mask adjacent to the mouth of the wearer.

8. The mask of claim 7 wherein the film insert is about 100-110 mm horizontally and about 45-50 mm vertically.

9. The mask of claim 6 wherein the regenerated cellulose film is inserted between layers of a cloth mask to enhance protection of the mask against viral particles.

10. The mask of claim 6 wherein the entire body portion comprises the regenerated cellulose film.

11. The mask of claim 10 wherein the regenerated cellulose film is pleated.

12. The mask of claim 6 wherein the fastening means are ear loops.

13. The mask of claim 12 wherein the ear loops comprise elastic material.

14. The mask of claim 6 wherein the fastening means are strings which tie around the ears or at the back of the head of the wearer.

15. The mask of claim 14 wherein the strings comprise a biodegradable material.

16. The mask of claim 6 further comprising a malleable member at the top binding of the body portion which can be configured to closely fit the contours of the nose and upper cheeks of the wearer.

17. The mask of claim 16 wherein the malleable member is a strip with a rectangular cross-section.

18. The mask of claim 16 wherein the malleable member comprises a moldable or a malleable metal or alloy, plastic, or any combination thereof.

19. The mask of claim 6 further fitted with a breathing valve or an air filter containing activated charcoal.
